(19) United States
(12) Patent Application Publication
(10) Pub. No.: US 2004/0085564 A1
(43) Pub. Date: May 6, 2004

(54) Image forming systems and image forming methods

(76) Inventors: Brian D. Peavey, Kuna, ID (US); Gregory E. Perkins, Meridian, ID (US); Rose E. Wiegley, Eagle, ID (US); David L. Lanning, Eagle, ID (US)

Correspondence Address: HEWLETT-PACKARD COMPANY, Intellectual Property Administration, P. O. Box 272400, Fort Collins, CO, 80527-2400, US

(21) Appl. No.: 10/697,750

(22) Filed: Oct. 29, 2003

Related U.S. Application Data
(63) Continuation of application No. 09/395,311, filed on Sep. 13, 1999.

(51) Int. Cl. G06F 15/00; H04N 1/46

(52) U.S. Cl. 358/1.13; 358/1.15; 358/537; 358/524

(57) ABSTRACT

Image forming systems and image forming methods are provided. According to one aspect of the present invention, an image forming system comprises: a host computer including: a memory device configured to store original data; and an interface configured to receive edits of the original data providing edit data; and an image forming device including: an input coupled with the host computer and configured to receive the original data and the edit data; a processor configured to process the original data prior to the image forming device receiving the edit data, and to process the edit data after the processing the original data; and an image engine configured to form an image corresponding to the processed original data and the processed edit data.

### FIELD OF THE INVENTION

The invention relates to image forming systems and image forming methods.

### BACKGROUND OF THE INVENTION

Document preparation has become increasingly sophisticated in recent years. Conventional laser printers, ink jet printers, facsimile devices, etc. have continued to evolve to provide advances including increased throughput and improved imaging.

Regarding printing applications, conventional printer configurations are typically coupled with a host computer system, or alternatively, with numerous host computer systems via a network. The host computer system is configured to interface with the appropriate printer. The host system may be arranged to download a print job to the printer via an appropriate connection. Some conventional printers are configured to parse the incoming data, to rasterize the data, and to print an image corresponding to the data.

Such conventional arrangements provide a driver, such as a page description language (PDL) driver, within the host computer system. Exemplary page description languages include PCL and PostScript. The associated printer includes a parser which is configured to operate in conjunction with the appropriate page description language driver of the host computer system. The attached printer may have plural page description language parsers for use with multiple drivers.

Following processing within the appropriate page description language parser, the received data is rasterized and applied to the print engine of the printer. Thereafter, imaging of the data upon media is usually performed.

During document creation within the host computer, a user invokes a word processor or other computer application to create the document. One of the readily recognized advantages of utilizing a word processor within the host computer system is the ease of editing of such documents being created. For example, text may be blocked, copied, cut, pasted, etc., utilizing conventional word processor programs. The documents are printed after the user has completed the creation and any editing of such documents.

At this point, typical conventional software of the associated host computer sends individual pages of the document to the printer. The document is applied to the printer one page at a time. This conventional arrangement has been observed to consume periods of time before the printer actually begins printing the document. Such periods of time have been observed to be particularly acute when the documents being imaged are long and/or complex. If complex pages are involved, there is an increased probability that substantial delays will be experienced between printing successive pages of the document.

Therefore, a need exists to provide improved image forming devices and image forming methods.

### SUMMARY OF THE INVENTION

The invention provides image forming systems and image forming methods.

According to one aspect of the present invention, an image forming system comprises: a host computer including: a memory device configured to store original data; and an interface configured to receive edits of the original data providing edit data; and an image forming device including: an input coupled with the host computer and configured to receive the original data and the edit data; a processor configured to process the original data prior to the image forming device receiving the edit data, and to process the edit data after the processing the original data; and an image engine configured to form an image corresponding to the processed original data and the processed edit data.

Another aspect of the present invention provides an image forming method comprising: providing an image forming device; first receiving original data within the image forming device; first processing the original data using the image forming device; second receiving edit data of the original data within the image forming device; second processing the edit data using the image forming device; and forming an image after the processings corresponding to the original data and the edit data.

Another aspect provides an image forming method comprising: providing a host computer; providing an image forming device; providing original data using the host computer; first applying the original data to the image forming device; processing the original data using the image forming device; editing the original data providing edit data using the host computer; second applying the edit data to the image forming device; processing the edit data using the image forming device after the second applying; and forming an image according to the original data and the edit data after the processings.

Other features and advantages of the invention will become apparent to those of ordinary skill in the art upon review of the following detailed description, claims, and drawings.

### DESCRIPTION OF THE DRAWINGS

FIG. 1 is an illustrative representation of an exemplary image forming system.

FIG. 2 is a functional block diagram of an exemplary host computer of the image forming system.

FIG. 3 is a functional block diagram of an exemplary image forming device of the image forming system.

FIG. 4 is a functional block diagram of exemplary firmware of the imaging forming device.

FIG. 5 is a functional block diagram illustrating exemplary data processing operations of the image forming device.

FIG. 6 is a flow chart illustrating exemplary operations of the host computer.

FIG. 7 is a flow chart illustrating exemplary operations of the image forming device.

### DETAILED DESCRIPTION OF THE INVENTION

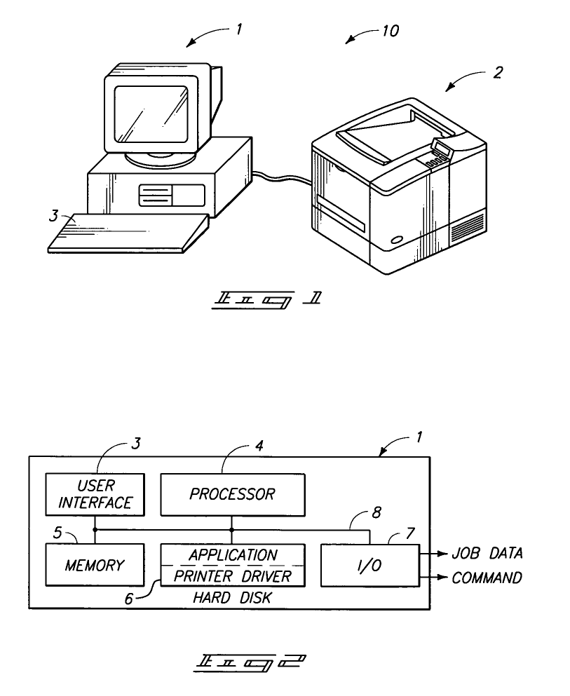

Referring to FIG. 1, an exemplary image forming system 10 is shown. The depicted image forming system 10 includes a host computer 1 and an image forming device 2. Host computer 1 and image forming device 2 are coupled via a parallel connection in the described embodiment.

Host computer 1 is configured as a personal computer (PC) in the depicted arrangement. The described host computer 1 includes a processor, such as a Pentium (TM) processor available from Intel Corporation.

The depicted image forming device 2 includes a printer, such as a laser printer or an ink jet printer. The present invention is not limited to the disclosed printer arrangement but is also applicable to other image forming devices. Exemplary alternative image forming devices 2 include facsimile devices, copiers, mopiers, other multiple function peripheral devices, etc.

Host computer 1 of the depicted arrangement includes a user interface 3. A user of image forming system 10 inputs original data, edit data and commands via user interface 3. User interface 3 comprises a keyboard in the depicted embodiment.

Original data as used herein refers to data to be imaged using image forming device 2. Exemplary original data includes data of a word processor document or data from other host computer applications such as an image manipulation application (e.g., Photoshop® available from Adobe Systems, Inc.) or a spreadsheet application, for example. The original data may be retrieved from memory within host computer 1, retrieved from a network (not shown), created or entered by the user, etc. Edit data as used herein refers to edits made to the original data.

Such can include additions, deletions, corrections or other alterations using an appropriate host computer application, for example. Accordingly, host computer 1 receives edit data of the original data in the described configuration.

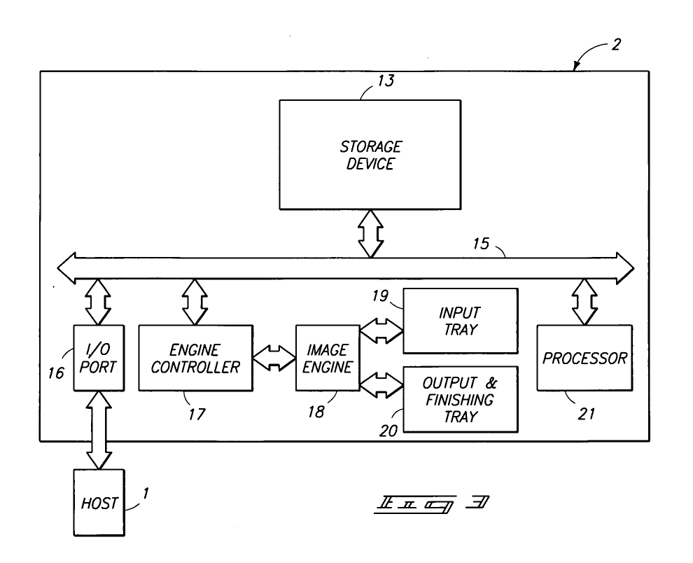

Referring to FIG. 2, the depicted host computer 1 includes user interface 3, a processor 4, a memory 5, a hard disk 6, an input/output (I/O) port 7 and a bus 8. Bus 8 operates to interconnect components 3-7.

Processor 4 is configured to control operations of host computer 1 responsive to executable instructions. For example, hard disk 6 stores initial boot instructions, image specification instructions and printer driver instructions for execution by processor 4. Exemplary image specification instructions include word processor instructions, image manipulation instructions, spreadsheet instructions, etc. Instructions of other applications may be utilized. Responsive to appropriate key strokes via user interface 3, processor 4 executes an application, such as a word processor or other host computer application, to provide desired image creation and editing. Hard disk 6 is also configured to store documents comprising original data.

Appropriate portions of an executed application may be temporarily stored within memory 5 which includes random access memory (RAM) and read only memory (ROM) in the described configuration. During execution of the appropriate host computer application, a user may input commands via user interface 3. Such commands can be implemented to initiate the formation of images within image forming device 2 as described below.

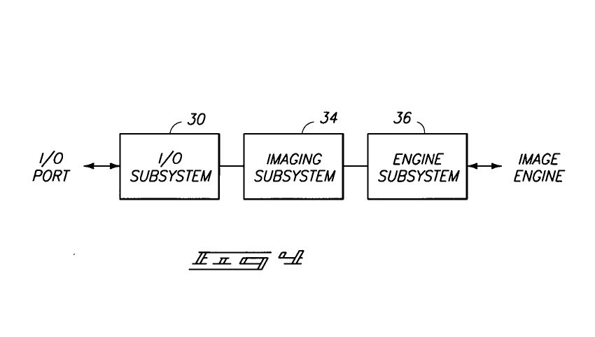

Referring to FIG. 3, the depicted embodiment of image forming device 2 comprises a storage device 13. An exemplary storage device 13 includes a hard disk storage device, a random access memory (RAM) device, and/or a read only memory (ROM) device. Storage device 13 is coupled with a bus 15. Other configurations of image forming device 2 are possible.

Additional hardware of the depicted image forming device 2 includes an input/output (I/O) port 16, image engine controller 17, image engine 18, input tray 19, and output and finishing tray 20. Image forming device 2 additionally includes a processor 21, such as a dedicated microprocessor, configured to control functions of image forming device 2. Processor 21 communicates with other hardware elements of image forming device 2 via bus 15.

I/O port 16 comprises an input/output device adapted to couple with host computer 1. I/O port 16 comprises a parallel interface which provides communications between image forming device 2 and host computer 1 in the described arrangement. I/O port 16 receives page description language data from host computer 1 for processing within image forming device 2 in accordance with the described embodiment. More specifically, original data and edit data to be imaged are applied from host computer 1 to image forming device 2 via I/O port 16 in accordance with the described embodiment.

Image engine controller 17 and associated image engine 18 are coupled with bus 15 and provide image output capability for image forming device 2. Image engine 18 is configured to form an image corresponding to the original data and edit data. In the described printer embodiment, image engine 18 is a print engine for printing images corresponding to the original data and edit data upon media.

Sheet media is pulled from input tray 19 into image engine 18 and subsequently directed to output and finishing tray 20. Output and finishing tray 20 includes, in an exemplary embodiment, finishing feature mechanisms such as sheet registration, binding, stapling, punching, and the like, and may include one or more bins for collation or “mailbox” usage purposes. Input tray 19 may also include a plurality of input trays for varied media selection.

According to the described embodiment, image engine 18 is a multi-resolution capable engine. For example, it can print, selectively, at 600 or 1200 dots per inch (dpi). For purposes of this disclosure, image engine 18 is a laser arrangement that employs an electrophotographic drum imaging system. Other image forming systems are utilized in other configurations.

RAM of storage device 13 provides main memory storage capabilities within image forming device 2 for storing print job data streams received from host computer 1 in the described embodiment. Further, RAM of storage device 13 is utilized to store processed data within image forming device 2. RAM of storage device 13 may be referred to herein as mass storage memory.

ROM of storage device 13 contains firmware which controls the operation of processor 21 and image forming device 2. Exemplary firmware code stored in ROM of storage device 13 includes an input/output (I/O) subsystem, an imaging subsystem, and an engine subsystem.

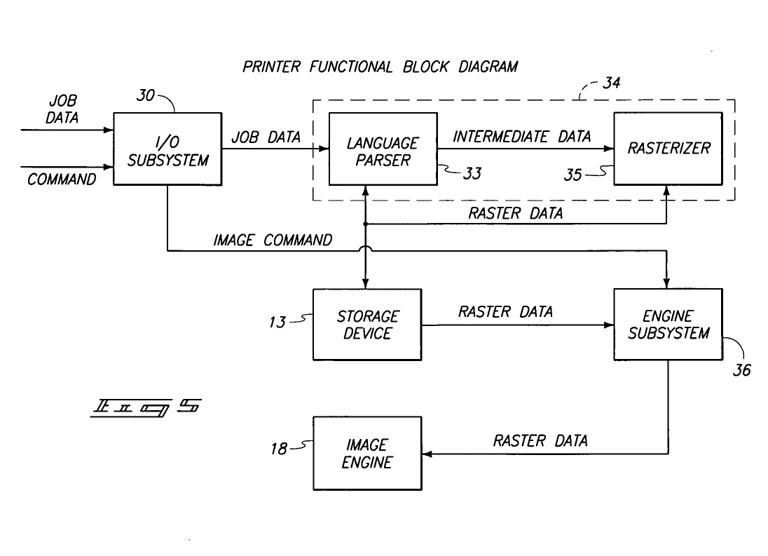

Referring to FIG. 4, firmware subsystems of image forming device 2 are illustrated. The firmware of the exemplary image forming device 2 provides an I/O subsystem 30, an imaging subsystem 34, and an engine subsystem 36. I/O subsystem 30 is operable to accept inbound data received from I/O port 16 and prepare outbound data for communication via I/O port 16. I/O subsystem 30 is configured to strip I/O specific data from the received data and pass the remaining data (e.g., page description language) to imaging subsystem 34.

In general, the operation of image forming device 2 commences responsive to the reception of page description data from host computer 1 via I/O port 16 in the form of a print job data stream. Such is typically initially the original data corresponding to an unedited document, for example. Edit data corresponding to editing of the original data follows as such edits are made. The page description data is initially placed in RAM of storage device 13.

Processor 21 accesses the page description language and performs initial operations, if any.

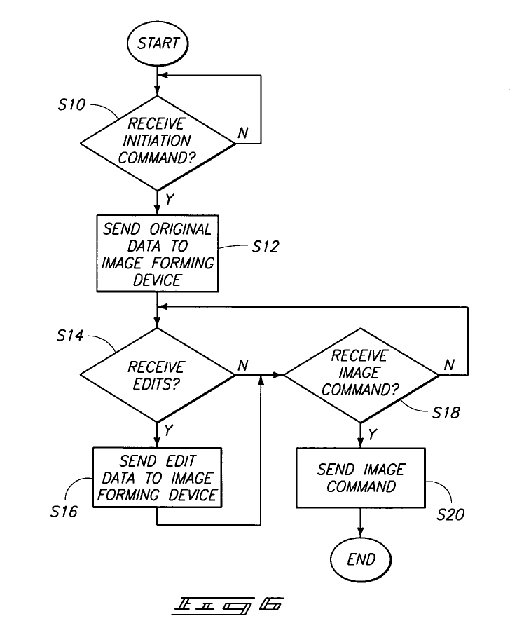

Thereafter, processor 21 builds a display command list using imaging subsystem 34. Imaging subsystem 34 contains a parser and rasterizer (parser and rasterizer are shown in FIG. 5) configured to respectively parse and rasterize a data stream, including original data and edit data, to be printed.

In particular, imaging subsystem 34 is configured in the described arrangement to process original data and edit data to convert page description language data received from host computer 1 to a display command list. Individual display commands define an object to be printed on a page. Imaging subsystem 34 includes rasterizer firmware configured to convert individual display commands to an appropriate bit map (rasterized strip) and distribute the bit map into RAM of storage device 13. Compression firmware is provided in some embodiments to compress the rasterized strips in the event insufficient memory exists in RAM of storage device 13 for storing the rasterized strips. The rasterized data may be retrieved from RAM of storage device 13 by engine subsystem 36. Engine subsystem 36 interfaces with image engine 18 to provide the rasterized data upon the media. Rasterized strips of data are passed to image engine 18 by image engine controller 17 thereby enabling the generation of an image (i.e., text, graphics, etc.) when a page is closed for processing (i.e., all strips have been evaluated, rasterized, compressed, etc.) and the user inputs an “image” or “print” command using host computer 1. Engine subsystem 36 controls the sequencing and transferring of page strips to image engine controller 17. Engine subsystem 36 additionally controls the operation of image engine controller 17 and image engine 18 in the described configuration. Referring to FIG. 5, imaging operations of image forming device 2 in accordance with aspects of the present invention are described in further detail. Utilizing host computer 1, a user initially creates a document and/or begins editing a document to be imaged. In one configuration, printer driver software executed by host computer 1 is arranged to automatically send the document (i.e., original data) to image forming device 2 once the document is created or retrieved from an associated memory device (e.g., hard disk 6).

Alternatively, the printer driver software of host computer 1 is configured to await receipt of a command from the user to instruct host computer 1 to begin transferring the document (i.e., original data) to image forming device 2. An exemplary command is a “soft print” or “pre-print” command. The user proceeds in typical applications to edit the document, add data to the document, etc. while the original data is sent by host computer 1 to image forming device 2.

Thereafter, the printer driver software of host computer 1 sends fragments of the document that have been added, amended or changed (i.e., edit data) since the last transfer of original data or edit data to image forming device 2.

Image forming device 2 processes the original data and any edit data upon receipt. Such processing comprises parsing and/or rasterizing the data in the described embodiment. Image forming device 2 prepares the document for imaging or printing so that such imaging or printing can occur immediately upon instruction from host computer 1.

More specifically, the user issues an image command such as a “hard print” or “actual print” command to begin the actual imaging or printing upon media. Image forming device 2 thereafter immediately images or prints processed data. Any data not yet processed is imaged or printed following the processing thereof.

As shown in FIG. 5, following receipt of job data from host computer 1, I/O subsystem 30 passes the received job data to imaging subsystem 34. Imaging subsystem 34 includes a language parser 33 and a rasterizer 35 to process the received job data. Language parser 33 receives the job data and parses the job data to provide intermediate data. The intermediate data is applied to rasterizer 35 which provides raster data. The raster data is applied to RAM of storage device 13 comprising a mass storage device in the described embodiment. Unprocessed job data and\or intermediate data may also be applied to RAM of storage device 13 for storage. In such arrangements, RAM of storage device 13 applies unprocessed job data to language parser 33 or intermediate data to rasterizer 35 for processing as described above.

During typical operations, RAM of storage device 13 stores processed raster data for subsequent application to engine subsystem 36. Following completion of the editing or creation of the document, a user can input the image command via host computer 1 which is subsequently applied to I/O subsystem 30. I/O subsystem 30 applies the image command to engine subsystem 36. Engine subsystem 36 receives raster data from RAM of storage device 13 and provides the data to image engine 18 following receipt of the image command. Image engine 18 images the received raster data upon media in accordance with the described embodiment.

In accordance with the present invention, image engine 18 creates the images at increased rates, especially when complex data is being imaged. Image engine 18 receives the rasterized data and initiates imaging immediately at full printer speed.

As the user creates and edits a document, the host application of host computer 1 sends job data of the document to image forming device 2. If a user makes a change to the document corresponding to data already sent to image forming device 2, edit data corresponding to the edits or modified page is transmitted to image forming device 2. When the user is done editing the document, the user via the host application sends the image command to image forming device 2 to initiate imaging of the appropriate, prerasterized document.

Accordingly, processor 21 of the image forming device 2 is configured in some aspects to process original data received from host computer 2 prior to receiving the edit data. Processor 21 is configured to process the edit data after receiving the original data as such edit data is received. Such minimizes processing of job data following an image command from the user and results in imaging of increased speed. Typically, a large portion of the data (if not all the data) is already processed prior to the commencement of actual imaging or printing.

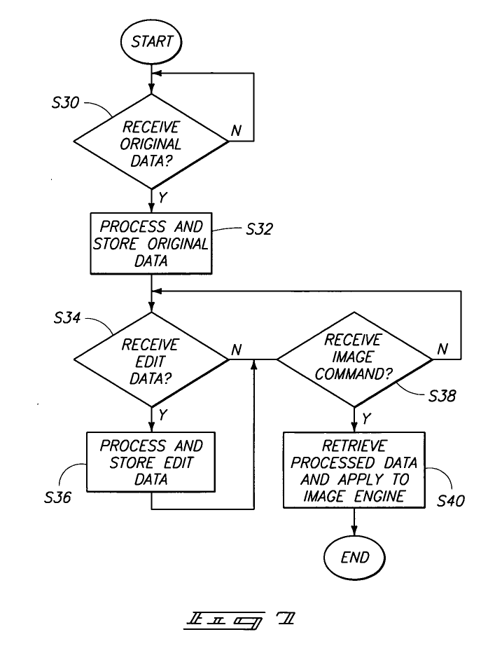

Referring to FIG. 6, one methodology for implementing host computer 1 operations is illustrated. A set of executable instructions configured to implement the depicted methodology may be stored within hard disk 6 of host computer 1. Processor 4 retrieves such stored set of executable instructions during imaging operations. Alternatively, the depicted methodology is implemented within hardware of host computer 1 in another arrangement.

Initially, processor 4 proceeds to step S10 to determine whether an initiation command has been received to initiate pre-print processing of the document including processing the original data. Such a command (e.g., the pre-print command) is implemented as a positively issued command by the user in one embodiment. Alternatively, the initiation command is issued automatically by host computer 1 upon retrieval of a document to be imaged. Processor 4 idles at step S10 until such an appropriate initiation command is received. At step S12, processor 4 begins to send original data corresponding to the user document to image forming device 2 following receipt of the initiation command. Such job data is sent via I/O port 7 of host computer 1 to I/O subsystem 30 of image forming device 2.

Processor 4 next proceeds to step S14 to determine whether a user has inputted edits to the subject document. Such edits can be inputted via user interface 3. If edits are received at step S14, processor 4 proceeds to step S16. Alternatively, if no edits are received at step S14, processor 4 proceeds directly to step S18.

At step 516, processor 4 sends edit data to image forming device 2. Such edit data includes fragments of the document actually edited by the user to update the original data already forwarded to image forming device 2. Such transfer of edit data is transparent to the user and occurs automatically after the inputting of the desired edit in accordance with one embodiment.

At step S18, processor 4 determines whether an image command was received from user interface 3. The user can input the image command when no further edits of the subject document are to be made and the document is ready to be imaged. If no image command is received at step S18, processor 4 returns to step 514. Alternatively, if a print command is received at step S18, processor 4 proceeds to step S20.

At step S20, processor 4 issues an image command to image forming device 2. Thereafter, image forming device 2 begins imaging of the subject document including the original data and edit data, if any.

Referring to FIG. 7, operations of image forming device 2 implemented by firmware are shown. Alternatively, the depicted methodology is implemented within hardware of image forming device 2 in another arrangement.

Initially at step S30, processor 21 monitors for the presence of original data received from host computer 1. Processor 21 idles at step S30 until original job data is received.

At step S32, processor 21 processes and stores the received original data utilizing the firmware and RAM of storage device 13 of image forming device 2. Such processing includes parsing and rasterizing the received data.

At step S34, processor 21 determines whether edit data is received from host computer 1. If so, processor 21 proceeds to step S63. Otherwise, processor 21 proceeds directly to step S38.

Processor 21 processes and stores edit data using firmware and RAM of storage device 13 at step S36. Following the execution of step S36, processor 21 proceeds to step S38.

At step S38, processor 21 monitors for the presence of an image command. If no image command is received, processor 21 returns to step S34. If an image command is received at step S38, processor 21 proceeds to step S40.

At step S40, processor 21 retrieves processed data (e.g., original data and any edit data) from RAM of storage device 13 and applies the processed data to engine subsystem 36 and image engine 18 for imaging.

The protection sought is not to be limited to the disclosed embodiments, which are given by way of example only, but instead is to be limited only by the scope of the appended claims.

What is claimed is:

1. An image forming system comprising:
a host computer including:
a memory device configured to store original data; and
an interface configured to receive edits of the original data providing edit data; and
an image forming device including:
an input coupled with the host computer and configured to receive the original data and the edit data:
a processor configured to process the original data prior to the mage forming device receiving the edit data, and to process the edit data after the processing the original data; and
an image engine configured to form an image corresponding to the processed original data and the processed edit data.

2. The system according to claim 1 wherein the processor of the image forming device is configured to rasterize the original data and the edit data to provide the processing.

3. The system according to claim 1 wherein the interface of the host computer and the input of the image forming device are individually configured to receive commands and the image engine is configured to form the image responsive to the commands.

4. The system according to claim 1 wherein the image engine comprises a print engine configured to form the image upon media.

5. The system according to claim 1 wherein the host computer includes a processor configured to execute image specification instructions and printer driver instructions.

6. An image forming method comprising:
providing an image forming device;
first receiving original data within the image forming device;
first processing the original data using the image forming device;
second receiving edit data of the original data within the image forming device;
second processing the edit data using the image forming device; and
forming an image after the processings corresponding to the original data and the edit data.

7. The method according to claim 6 further comprising receiving an image command after the first receiving.

8. The method according to claim 6 further comprising receiving an image command after the second receiving.

9. The method according to claim 6 wherein the first processing and second processing individually comprise rasterizing.

10. The method according to claim 6 wherein the forming comprises forming the image upon media using a print engine.

11. The method according to claim 6 further comprising:
providing a host computer; and
executing image specification instructions using the host computer providing the original data and the edit data.

12. The method according to claim 8 wherein the first processing comprises beginning processing before the second receiving.

13. The method according to claim 6 wherein the second receiving comprises receiving after the first receiving of the entire original data.

14. An image forming method comprising:
providing a host computer;
providing an image forming device;
providing original data using the host computer;
first applying the original data to the image forming device;
processing the original data using the image forming device;
editing the original data providing edit data using the host computer;
second applying the edit data to the image forming device;
processing the edit data using the image forming device after the second applying; and
forming an image according to the original data and the edit data after the processings.

15. The method according to claim 14 further comprising applying an image command to the image forming device using the host computer after the first applying and the forming is responsive to the applying the image command.

16. The method according to claim 14 further comprising applying an image command to the image forming device using the host computer after the second applying and the forming is responsive to the applying the image command.

17. The method according to claim 14 wherein the processings individually comprise rasterizing.

18. The method according to claim 14 wherein the forming comprises forming the image upon media using a print engine.

19. The method according to claim 14 further comprising executing image specification instructions using the host computer providing the original data and the editing.

20. The method according to claim 14 wherein the processing the original data comprises beginning processing before the second applying.
